(19) United States
(12) Patent Application Publication
(10) Pub. No.: US 2023/0175541 A1
(43) Pub. Date: Jun. 8, 2023

(54) CONTROLLED FRICTION FOR SLIDING ASSEMBLIES

(71) Applicant: OMC2, LLC, Peekskill, NY (US)

(72) Inventors: Grant Kenji Larsen, Millbrook, NY (US); James Edward Tersigni, Holmes, NY (US)

(21) Appl. No.: 18/074,127

(22) Filed: Dec. 2, 2022

Related U.S. Application Data
(60) Provisional application No. 63/285,578, filed on Dec. 3, 2021.

(51) Int. Cl. F16B 9/00

(52) U.S. Cl. CPC F16B 9/07

(57) ABSTRACT

An interface component is disposed between a movable block and a support member, such as a linear rail. The interface includes a number of independent flexures, each providing an axially projected contact area extending toward the support member that varies in shape and spring force according to contact force with the support member. The flexures may be arranged collectively to provide complementary radial forces on the support member, thus providing force-controlled contact points with the support member that can individually yield to local surface irregularities in the support member, while maintaining a balanced array of radial contact forces with the support member.

### RELATED APPLICATIONS

This application claims priority to U.S. App. No. 63/285,578, filed on Dec. 3, 2021, the entire content of which is hereby incorporated by reference.

### TECHNICAL FIELD

This disclosure relates to controlled friction for sliding assemblies, and more specifically to methods and systems that facilitate low-friction or controlled friction engagement of a sliding assembly to a rail.

### BACKGROUND

There remains a need for improved sliding assemblies.

### SUMMARY

A moveable member, such as a movable block, is slidably coupled to a support member, such as a rail, through an interface component configured to slide relative to the support member. The interface includes flexures providing an axially projected contact area extending toward the support member that varies in shape and/or spring force according to contact force with the support member. Each flexure has an independent spring profile that varies radially according to the contact force, while also resisting axial deflection (e.g., along an axis of motion along the support member) in order to retain the desired spring and contact characteristics as the flexure is axially loaded. The flexures may be arranged collectively to provide complementary radial forces on the support member, thus providing force-controlled contact points with the support member that can individually yield to local surface irregularities in the support member in order to provide more uniform overall sliding contact between the support member and the moveable member despite geometric irregularities or contaminants along the support member. Any number and type of these interfaces may be disposed within the moveable member to distribute contact forces as desired.

In one aspect, a system for coupling a block to a rail having an axis, as described herein, includes a substrate shaped along the axis to frictionally engage the block; and a plurality of flexural elements, each providing an axially projected contact area extending toward the rail that varies according to a contact force with the rail and each having a spring profile that varies radially according to the contact force with the rail while resisting axial deflection, wherein the plurality of flexural elements are arranged about the axis to provide complementary radial forces on the rail.

One or more of the plurality of flexural elements may include cantilevered arms extending at an angle to a direct radial path to the axis of the rail. At least one of the flexural elements may include a low-friction material on at least a portion of the axially projected contact area that contacts the rail when placed for use on the rail. At least one of the flexural elements may be supported by a rigid backstop positioned to increase resistance of the one of the flexural elements beyond a predetermined threshold. At least one of the flexural elements may include a compound engagement surface shaped to contact the rail along two or more different surfaces. The plurality of flexural elements may be directed radially outward to engage one or more interior cross-sectional surfaces of the rail. In another aspect, the plurality of flexural elements may be directed radially inward to engage one or more exterior cross-sectional surfaces of the rail. The plurality of flexural elements may include a first set of flexural elements imposing rotational forces in a first direction when loaded and unloaded, and a second set of flexural elements imposing rotational forces in a second direction opposing the first direction when loaded and unloaded.

In one aspect, the system may further include the block and the rail. The rail may be a linear rail. In another aspect, the rail may be a curvilinear rail. The system may also include a plurality of devices, each including a substrate shaped to engage the block and a plurality of flexural elements, the plurality of devices positioned along the block to engage the rail at different linear locations.

In one aspect, the substrate and the flexural elements may be formed of different materials. The flexural elements may be formed in a first cylindrical element nested within a second cylindrical element containing the substrate. The flexural elements may have a sliding friction controlled by one or more materials of the first cylindrical element. In another aspect, a spring behavior of the flexural elements may be controlled at least in part by a material of the second cylindrical element. The system may include a functional coating on one or more of the flexural elements.

The flexural elements may be formed of a material selected for elasticity and spring force of the flexural elements against the rail. In another aspect, at least one of the plurality of flexural elements may include a compound engagement surface for contacting the rail. One or more of the plurality of flexural elements may provide a non-linear spring force with a spring constant that increases with increasing radial force.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 shows a device for coupling a block to a rail.

FIG. 2 shows a device for coupling a block to a rail.

FIG. 3 shows an assembly for coupling a block to a rail.

FIG. 4 shows a device for controlled friction.

FIG. 5 shows an assembly for controlled friction.

FIG. 6 shows a device for controlled friction.

FIG. 7 shows a system for controlled friction.

FIG. 8 shows a system for controlled friction.

FIG. 9 shows an assembly for controlled friction.

FIG. 10 shows a device for controlled friction.

FIG. 11 shows a device for controlled friction.

FIG. 12A shows engagement of a flexural element with a rail.

FIG. 12B shows engagement of a flexural element with a rail.

FIG. 13 shows a flexural element with a compound engagement surface.

FIG. 14 shows a multi-part device for coupling a block to a rail.

### DETAILED DESCRIPTION

All documents mentioned herein are incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

The devices, systems, and methods described herein generally involve enhancements for the sliding (or other movement) of at least one structural member relative to another structural member. To this end, in some aspects, the present teachings include a substrate disposed between at least two structural members, where one of the structural members is configured to move relative to another one of the structural members (e.g., where one structural member moves along, about, or within another structural member), and where the substrate is structurally configured to enhance this movement such as through the inclusion of a plurality of flexural elements. It will be understood that, in this context, “enhancing” or “controlling” movement (or the like) between two or more structural members can include controlling the relative movement (e.g., a speed, an acceleration, an alignment, a direction, and so on) and/or an engagement between the structural members such as the frictional engagement between the structural members. For example, in certain aspects, enhancing movement between two or more structural members may include reducing or increasing the frictional engagement between the members. In this latter example, the frictional engagement may be statically controlled, e.g., through the design of flexural elements to meet a desired friction profile, or dynamically controlled, e.g., by controlling the shape or deflection of such elements actively during use in order to facilitate user-controlled modifications to frictional engagement during use. Also or instead, enhancing movement between two or more structural members may include accommodating a geometric feature of one or more of a movable member and a static member. This may include intentional geometric features of one or more of these members (e.g., its designed size, shape, and features) and/or unintentional geometric features of one or more of these members such as surface defects and the like. Thus, it shall be understood that several forms of control can be provided using the present teachings, including without limitation: through use of a control system or the like that can affect movement between two or more structural members; through the use of a control system that can affect movement (or another property) of specific flexural elements themselves that engage with one or more structural members (e.g., with or without otherwise controlling the movement between two or more structural members, such as through agitating the flexural elements via ultrasonic vibration of embedded transducers or the like); through the specific selection and/or design of flexural elements that engage with one or more structural members (e.g., through defining the physical constants and morphology, thereby ‘controlling’ the physical form of the flexural elements); and so on.

One example of the present teachings includes a device disposed between a sliding member and a member upon which the sliding member slides—e.g., a static member such as a rail—where the device is structurally configured to enhance sliding movement of the sliding member as described herein. Thus, one salient example of the present teachings includes a sliding block or the like that slides along (e.g., on, within, or otherwise) a rail or the like. However, it will be understood that, while the present disclosure may emphasize an embodiment including a “block” and a “rail,” in many instances, and unless stated expressly to the contrary or otherwise clear from the context, such “blocks” and “rails” may be substituted for other structural members without departing from the scope of this disclosure. It will also be understood that in general, either structure coupled through the disclosed interface may be a moving structure, or a stationary structure, or some combination of these. In general, the movement of interest is a sliding movement of one structure relative to another, as facilitated by the interface components described herein, rather than the absolute movement of one structure or the other within a particular frame of reference.

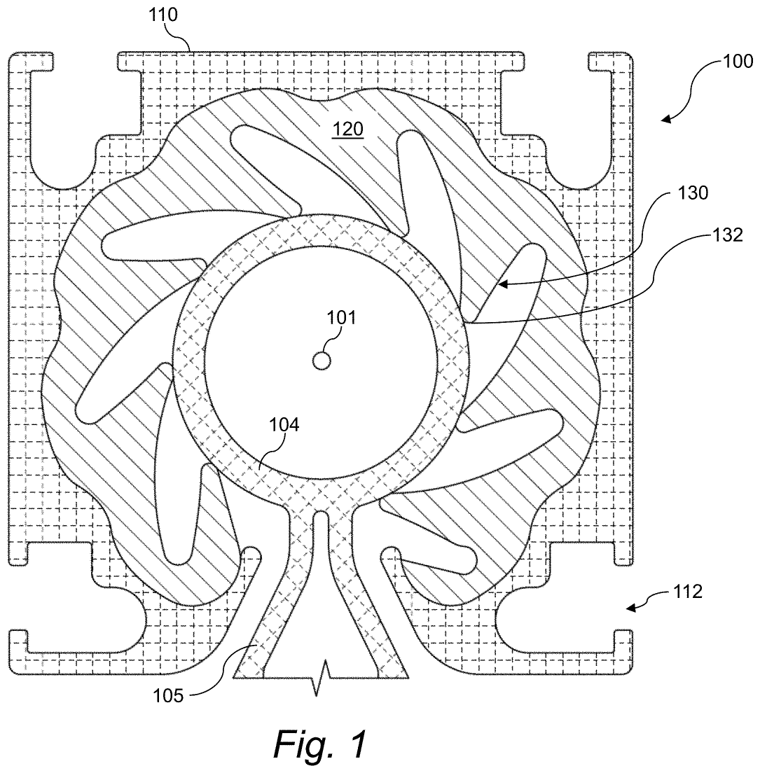

FIG. 1 shows a device for coupling a block to a rail. As discussed above, it will be understood that the block 110 and the rail 104 shown in this figure are provided by way of example only, and that the device 100 as described herein may be used to facilitate movement of other types of structural members relative to one another. In general, the block 110 may be movably coupled (e.g., slidably coupled) to the rail 104 through the device 100, where the device 100 provides an interface that is retained in the block 110 for movement with the block 110 along the rail 104. The device 100 may enhance such movements in one or more ways as described herein. The device 100 may include a substrate 120 and a plurality of flexural elements 130, where one or more of the flexural elements 130 may provide force-controlled contact points with the rail 104, and that can individually yield to surface irregularities (and the like) in the rail 104 to provide more uniform precision movement (e.g., sliding contact) between the rail 104 and the block 110. It will be appreciated that, while illustrated as a discrete component, in some embodiments the substrate 120 and/or flexural elements 130 may also or instead be integrated into the block 110 or the rail 104. For example, the block 110 may provide the substrate 120 for the flexural elements 130, and this entire assembly may be fashioned from a single, composite material.

The block 110 may have any suitable shape. Thus, although shown as an element with a cross-section resembling a rectangle, other shapes are also or instead possible for the block 110, which is merely shown this way for convenience and by way of example, not limitation. For example, the block 110 may have a cross-section substantially resembling another polygon, such as a triangle, other quadrilateral, pentagon, and so on. Also, or instead, the block 110 may have a cross-section substantially resembling a curved shape, such as a circle, an oval, or other curves. Also, or instead, the block 110 may have a non-uniform shape or otherwise unconventional shape. Thus, in general and as described herein, the block 110 may be any structural member that is structurally configured to engage with (directly and/or indirectly) and move relative to a rail 104, which similarly may be any structural member relative to which another member is structurally configured to move.

As explained in more detail below, in some aspects, the block 110 (as shown in the figure or otherwise) may form part of the device 100 for coupling another movable member to a structural member such as the rail 104. That is, the block 110 as shown may represent a carrier or backing for the device 100, where a movable member is engaged thereto (e.g., coupled to an exterior of the block 110 shown in the figure). To this end, the block 110 may include one or more attachment features 112 that can permit the block 110 to move, or be moved by, an attached member or assembly. Although these attachment features 112 are shown as voids configured for mechanically keying with another element, other shapes, sizes, and arrangements for such attachment features 112 are also or instead possible, including projections or other features.

The rail 104 may include an axis 101 disposed therethrough—where it will be understood that this axis 101 would traverse into and out of the page and is thus represented by a point in the figure—and the block 110, and thus the device 100, may be shaped along this axis 101. In other words, the rail 104 may include a length along the axis 101, where the device 100 couples the block 110 to the rail 104 along this axis 101. In some implementations, the rail 104 includes a linear rail upon which the block 110 is structurally configured to slide. The rail 104 may also or instead include a curved rail or the like. Also, or instead, although the block 110 is shown as disposed on an exterior surface of the rail 104, the block 110 may also or instead be structurally configured to engage the rail 104 along an interior surface thereof. The rail 104 may be static relative to the block 110 in some implementations. In other implementations, each of the rail 104 and the block 110 are configured to move, or the block 110 remains static while the rail 104 is the component that moves. It will be understood that, although a supported rail 104 is shown in the figure, an unsupported rail 104 may also or instead be used—e.g., an unsupported or partially supported rail 104 may be used in the present teachings (e.g., where the rail 104 lacks continuous or substantially continuous supports such as the legs 105 shown in the figure, for example where a rail 104 is supported on only its ends), with one or both of a full or partial circumferential block 110. It will also be understood that, although the rail 104 is shown in the figure as having a substantially rounded (e.g., circular) profile, that other profiles are also or instead possible including a square, a triangle, an oval, or similar, or even some arbitrary cross-section, with flexural elements 130 structurally configured to engage with such a shape. By way of example, it may be advantageous to have a non-round rail profile, because this can allow the block 110 to be rotationally indexed on the rail 104—i.e., the block 110 may be mitigated or prevented from spinning on the rail 104, even without external rotational stabilization, and this can be quite desirable. Therefore, it shall be understood that, although the present disclosure may emphasize “radial” forces and features, in applications having non-round or arbitrarily shaped rails, the rail surface may not be normal relative to a radial projection from a centroid of the rail cross section, and thus the forces may not be purely radial, but may have a potentially significant component orthogonal to the radial direction (this may be especially salient if the rail 104 and block 110 shapes are designed to prevent or mitigate rotational motion of the block 110 around the axis of the rail 104).

An example of the block 110 and the rail 104 will now be described, where it will be understood that many other examples are also or instead possible. In one aspect, the rail 104 is a portion of a frame or structure of a positioning assembly (e.g., a one, two, or three axis positioning assembly) for a tool, where the block 110 is the tool or a component to which the tool is coupled. For example, the rail 104 may be a portion of a frame of an x-y-z positioning assembly for a motorized maneuverable tool such as a computer numerical control (CNC) machining tool, and the block 110 may couple with the machining tool for movement thereof along a tool path.

Thus, it will be understood that the present teachings may include solutions to enhance movement of a sliding member relative to a counterpart static member, and that this can be illustrated simply by the block 110 and rail 104 embodiment shown in the figure.

Turning back to the device 100, as discussed above, the device 100 may be structurally configured for coupling the block 110 to the rail 104, no matter the form or function of these elements. And the device 100 may include a substrate 120 and a plurality of flexural elements 130.

The substrate 100 may generally be disposed between the block 110 and the rail 104. And, in this manner, the substrate 120 may be shaped along the axis 101 to frictionally engage the block 110. That is, in certain aspects, the substrate 120 is engaged with the block 110 in a manner such that movement of the block 110 relative to the rail 104 will cause associated movement of the substrate 120 with the block 110. In some aspects, the substrate 120 may be part of the block 110 itself, e.g., a portion of the block 110 that faces the rail 104. Also or instead, the substrate 120 may generally conform to a shape of one or more of the block 110 and the rail 104 to couple these elements to one another. In this manner, the substrate 120 may act as an insert to fit on or within a portion of the block 110. In certain implementations, the substrate 120 is unable to move relative to the block 110, while in other aspects, the substrate 120 may be movable relative to the block 110.

In an aspect, the substrate 120 may include a sliding plastic sleeve that rides along the rail 104, which may include a round metal rod that acts as a static member in this particular arrangement. Thus, a system including the device 100 may for a linear rail or similar sliding structure. However, it will be understood that the use of a plastic material for the substrate 120 is merely provided by way of example, and other materials may be used. For example, the substrate 120 may be formed of TiN coated steel or the like.

The plurality of flexural elements 130 may extend from the substrate 120 toward the rail 104. In some aspects, the flexural elements 130 are extensions of the substrate 120 itself and formed of the same material; in other aspects, the flexural elements 130 are made from a different material relative to the substrate 120. Each of the plurality of flexural elements 130 may provide an axially projected contact area 132 extending toward the rail 104. In this manner, a flexural element 130 may include a projection—e.g., a finger-like projection—that extends toward the rail 104. And thus, in some aspects, a flexural element 130 may include a cantilevered arm extending from the substrate 120 (or otherwise from the block 110) toward the rail 104 at an angle to a direct radial path toward the axis 101, so that the arm is unsupported in at least one radially projected area, thus permitting the flexural element 130 to flex and deform in response to applied radial forces. In this general configuration, the cantilevered flexural member can provide a spring force when radially loaded, with the spring force controlled by the shape and thickness of the cantilevered arm of the flexural element and the material used to form the flexural element.

The tip or end portion of the flexural element 130 may include an axially projected contact area 132, e.g., with the apex or a nearby side surface moving into contact with the rail 104 as the flexural element 130 flexes to conform to the cross-sectional shape of the rail 104. Also or instead, the axially projected contact area 132 may include an additional feature such as a protrusion, a projection, an indentation, a ribbing, a specific texture, and so on, in order to control the amount and shape of contact surface.

The axially projected contact area 132 of one or more of the flexural elements 130 may vary according to a contact force with the rail 104. For example, the greater the contact force with the rail 104, the larger the axially projected contact area 132 may become. In another aspect, an increase force may cause a different portion of the flexural element 130, or an increase surface of the flexural element 130, to come in contact with the rail 104. In this manner, the degree of frictional engagement may be engineered to vary according to the contact force. While this might typically be expected to be an increase in frictional engagement as a radial force on one of the flexural elements 130 increases, this relationship may be modified, e.g., by having the flexural elements 130 yield to present a contact surface with a lower-friction surface material so that the static or sliding friction decreases over some range of increased radial forces.

The flexural elements 130 may each have a spring profile that varies radially according to contact force with the rail 104 while resisting axial deflection. That is, the flexural elements 130 may be formed as, or may otherwise act as, internal leaf springs that contact a surface of the rail 104. Through the inclusion of its flexural elements 130, the device 100 may provide a self-centering effect for a block 110 attached thereto. Also or instead, the device 100 may allow for the ability to compensate for defects in the rail 104 without impeding motion. This may advantageously permit manufacture of a highly resilient, low-friction slider mechanism using relatively low-cost materials.

The flexural elements 130 may be structurally configured such that their spring profile(s) allows for relatively small initial deflections with a light force (e.g., from a minor defect in the rail 104) and generally increasing resistance to greater deflection as each flexural element 130 becomes more physically displaced. For example, this may include a non-linear spring force with a very low spring constant at small deflections, and an increasingly large spring constant at higher deflections, or more generally, with a spring constant that increases with increasing radial force. It will be understood that the spring profile, and thus the nature of the deflection profile for the flexural elements 130, may more generally be controlled through the design (e.g., size, shape, and material) of the flexural elements 130. It will further be understood that, while it may be advantageous that the flexural elements 130 can provide a non-linear spring force in some cases, the flexural elements 130 may also or instead be structurally configured to provide a linear spring force, which may be desirous in certain applications.

In another aspect, one or more of the flexural elements 130 may be formed of a low-friction material, and/or include a coating of a low-friction material, in order to facilitate low-friction engagement with the rail 104. It can be difficult to generalize static and sliding frictional relationships, which may depend on, e.g., the two types of material in contact, surface texturing, physical contamination, existence of lubricants within the material-to-material interface, exterior conditions such as temperature and humidity, and so forth. However, there are a variety of suitable materials such as polytetrafluoroethylene, which is known for use as a hard, low-friction coating, and a number of other thermoplastics and the like such as nylon or acetal that have low coefficients of friction when running against mating metal surfaces. These and any other materials suitable for forming a low-friction interface with the rail 104 may be suitably adapted as a low-friction material and/or coating for flexural elements 130 as described herein. Further, the use of lubricants—dry and/or liquid lubricants—may be used in the present teachings. That is, the present teachings may include use of one or both of a substantially-permanently-affixed material coating, or an unaffixed powder and/or liquid coating such as an applied lubricant.

The plurality of flexural elements 130 may be arranged about the axis 101 to provide complementary radial forces on the rail 104. The arrangement of the flexural elements 130 may be adaptable to fit the form and/or intended use within a system, and/or to provide a predetermined enhancement for movement of the block 110 relative to the rail 104. In some aspects, the arrangement of the flexural elements 130 is achieved by the bending modulus of the material itself—e.g., where such a material may include Ultra-High Molecular Weight Poly-Ethylene (UHMW PE) or the like, which can be advantageous because of its flexural properties as well as its frictional and wear properties.

Because the material of the flexural elements 130 may be substantially flexible, the rigidity of the overall device 100—the substrate 120 and the flexural elements 130—may be significant. By way of example and as shown in the figure, the thickness of the substrate 120, which is disposed at the periphery of the device 100, may be relatively small to allow non-linear spring rates of each flexural element 130 due to complex bending and differential pivoting. However, where desired, greater rigidity may also be achieved by making the thickness of the substrate 120 larger, such that the volume of a flexural element 130 is a smaller fraction of the substrate 120 or other periphery backing material.

In some embodiments, the device 100 may be structurally configured for more complex spring behavior when loading and bending the flexural elements 130. For example, the substrate 120 and the flexural elements 130 may be, at least in part, surrounded by a sleeve of denser, rigid material, which may be the block 110 shown in the figure—i.e., where the block 110 forms a carrier or sleeve for the device 100 that provides a rigid backstop against deformation. Such a carrier or sleeve may be made of any rigid material to provide a backing force to the flexural elements 130, which may be relatively supple. For example, the sleeve may be formed of an extruded aluminum or similarly rigid material. As discussed above, such a carrier may include one or more attachment features 112 that can permit the carrier to move, or be moved by, an attached member or assembly.

In one aspect, the device 100 may structurally configured to attenuate vibration of the rail 104 or system, for example, by distributing vibrational energy and motion on one (radial) side of the substrate 120 through the centering spring network formed by the radially distributed flexural elements 130. Additionally, or alternatively, the flexural elements 130 may be agitated in an aspect (e.g., via ultrasonic vibration of embedded transducers or the like) to reduce the frictional engagement with the rail 104. In this manner, a material of the flexural elements 130 may be selected based on, inter alia, vibrational absorption properties. That is, because different materials have the ability to absorb and dissipate (as heat) vibrational energy, the flexural elements 130 may be selected to provide more or less absorption (e.g., the flexural elements 130 may be made of a rubber plastic instead of a hard plastic to provide more absorption).

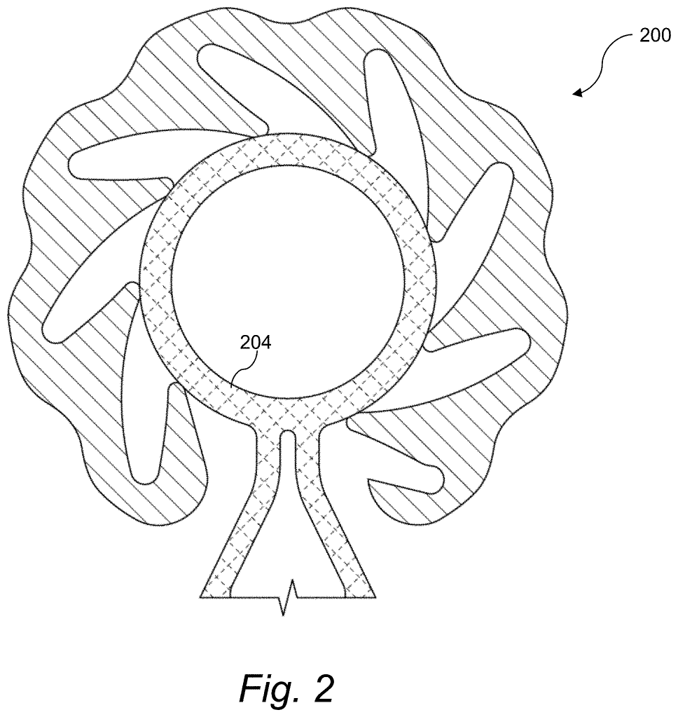

FIG. 2 shows a device for coupling a block to a rail. However, unlike the device 100 of FIG. 1, the device 200 sitting upon a rail 204 shown in FIG. 2 lacks a block, carrier, or sleeve. Thus, as noted above, the device 200 may lack such a carrier or sleeve, and may be used directly as a sliding block or the like with integral flexural elements.

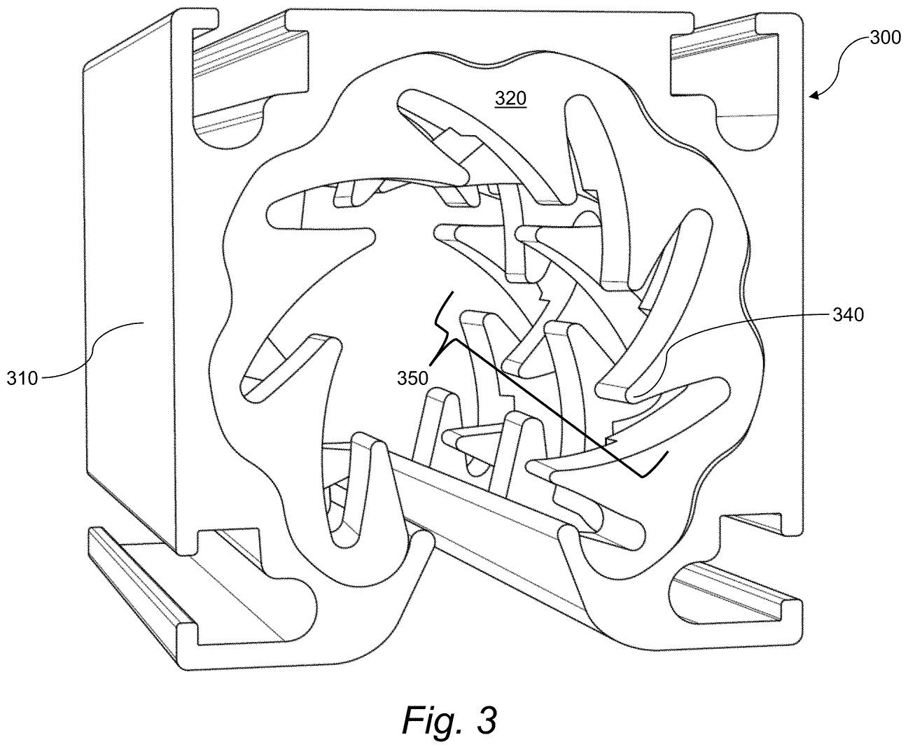

FIG. 3 shows an assembly for coupling a block to a rail. The assembly 300 may include a carrier 310 that is structurally configured to receive one or more inserts 350 therein or thereon, where each insert 350 may include a device as described herein featuring a substrate 320 and a plurality of flexural elements 340. The carrier 310 may be configured for movement (e.g., sliding movement) relative to another structure such as a rail or the like. Thus, in one aspect, the entire assembly 300 including multiple inserts 350 may be configured for movement, such as sliding movement and the like, along a rail or other structure. It will be understood that one or more of the carrier 310, the substrate 320, and the flexural elements 340 may be the same or similar to any as described herein.

As shown by this figure, the assembly 300 may include a number of inserts 350. For example, the assembly 300 may include multiple inserts 350, each having an associated plurality of flexural elements 340, thus increasing the number of points of contact from the axially projected contact area from the flexural elements 340 extending from the substrate 320 to engage with the structure relative to which the assembly 300 is configured to move. The increase in the number of points of contact may increase restoring forces along the assembly 300 when the assembly is moved (e.g., slid) relative to another structure such as a rail. In one aspect, this assembly 300 may provide a larger total centering and restoring force than an individual device, while individual flexural elements 340, which are greater in number, may each be more flexible, thus allowing greater accommodation of point defects along a rail or other structure upon which the assembly 300 slides. The total number of inserts 350 and/or the total number of flexural elements 340 may be relatively large, such that the deflection of one flexural element 340 is negligible in contributing to the deflection of the entire assembly 300. It will be understood that while four such inserts 350 are shown in the figure by way of example, the total number of inserts 350 may be greater or lesser, and may depend on the intended use and any other design considerations. Similarly, the total number of flexural elements 340 within each insert 350 may vary according to the desired function or form of each insert 350. In some aspects, each insert 350 is the same; in other aspects, one or more of the inserts 350 are different from one another—e.g., including a different material; including a different number, size, shape, or property of flexural elements 340, substrates 320, surface treatments, and so on.

In one aspect, the flexural elements 340 may have alternating circumferential orientations. This may be useful, for example, where spring compression and extension by the flexural elements 340 imposes tangential forces on an abutting rail, thus causing a net rotational force on the carrier 310 or a rail or the like to which it is slidably attached. In order to mitigate this rotational force, the flexural elements 340 may be arranged in offsetting orientations. In one aspect, this may include inserting multiple inserts 350 in asymmetric or opposing orientations along the axis. In another aspect, each insert 350 may be configured with an offsetting arrangement of flexural elements to balance rotational forces, e.g., as illustrated in FIG. 6, below. In another aspect, all of the flexural elements 340 may intentionally be placed with a common circumferential orientation in order to impart a rotational force as the flexural elements 340 are loaded and unloaded during use.

The assembly 300 may further include one or more end caps that retain the inserts 350 inside the carrier 340. An end cap may include plates with a relief shaped to accommodate the rail, and/or an end cap may include more complex parts, such as attachment features for external items and the like.

In some aspects, space may be provided inside the carrier 340, e.g., in between the flexural elements 340 and/or individual inserts 350. This space mitigate the accumulation and/or frictional effects of contaminants and debris. Also or instead, the space can provide room for cooling, irrigation, lubricant flow, and so on, for applications that might require these features. Additional internal features may also or instead be added in this available space, such as felt pads to contain and distribute lubricating oil, brushes or cleaning pads to continually sweep a rail or other structure for debris, and the like.

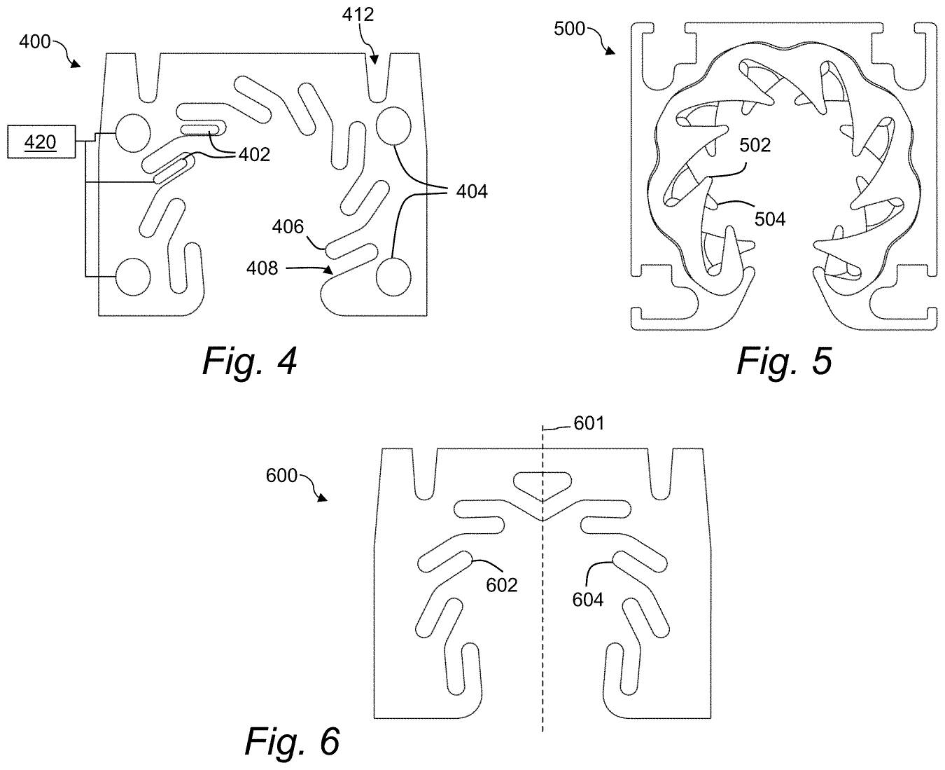

FIG. 4 shows a device for controlled friction. The device 400 may be similar to any of the other devices and assemblies described herein, and may include one or more of the features described herein. In the embodiment of FIG. 4, the device 400 includes a substantially full spiral design with flexural elements that result in a relatively linear load-deflection curve over a range until one or more of the flexural elements 406 contacts a surface 408 of the substrate. The device 400 may also include one or more notches 412. The notches 412 may be disposed on a top surface of the device 400 or any other locations, and may feature an angular design. In this manner, the notches 412 may be structurally configured to receive a wedge or shim therein to secure the device 400 with a block or other structure, or to adjust a friction fit to the block or spring tension about a rail (e.g., a round rail) to which the device 400 is coupled.

In one aspect, the device 400 may include one or more actuators, which can allow for an active change in the spring force and/or the contact force applied to a rail. This permits dynamic control of friction on demand. For example, if using plastic slider inserts, voids 402 can be made to allow pressurization with air or hydraulic fluids, creating variable deflection in each flexural element 406, and therefore variable friction. Other possible transducers 404 include piezoelectric transducers, magnetic coil transducers, electrostatic actuators for electromagnetic attraction and repulsion, among others. These can be used alone or in combination to variably control friction along a rail or the like. Alternatively, each individual flexural element may be individually controlled to provide differential loading in any direction. This can also or instead be employed to intentionally deflect the carrier or block in particular directions.

For example, if not all leaves are deflected the same way, there would be non-co-axial relative movement between a slider carrier and a rail. Such small angular deflections may result in a relatively net vector displacement in the axial direction. This may allow the slider to become a directional actuator, and move in one direction or the other. In another aspect, linear motion may be imparted by variably increasing and decreasing sliding friction in synchrony with a linearly reciprocating rail.

Active control may also or instead facilitate controlled braking, e.g., through selective application of ultrasound vibration (or other vibration as noted below) to reduce friction only when sliding is desired, or the selective application of radial forces through actuated flexural elements, or some combination of these. To facilitate this type of active control, control circuitry 420 such as a processor, input/output circuitry, and so forth may be included in the device 400 and/or associated hardware. In addition to or instead of use of ultrasonic vibration, sonic and even subsonic vibrations may be used. For example, in the case of sonic vibrations, moderate speeds may be achieved while maintaining a relatively high differential friction. And, in the case of subsonic vibrations, extremely slow speeds may be achieved, with little to no energy transfer into bulk displacements, e.g., allowing usage of the present teachings in delicate and/or silent applications.

In another aspect, flexural elements 406 may extend axially, that is, cantilevered along the rail rather than around the rail, thus promoting movement in a particular direction along a rail or the like as the flexural elements 406 are loaded and unloaded.

FIG. 5 shows an assembly for controlled friction. The assembly 500 may be similar to any of the other devices and assemblies described herein, and may include one or more of the features described herein. The assembly 500 may include a substantially full, spirally-arranged set of flexural elements and counter-positioned inserts. In this arrangement, a first set of flexural elements 502 may tend to impose rotational forces in one direction (e.g., clockwise) as the flexural elements 502 are loaded and unloaded, while a second set of flexural elements 504 tend to impose rotational forces in a second, opposing direction (e.g., counterclockwise) as the flexural elements 504 are loaded and unleaded. This configuration may allow for the net torque due to equalize in order to reduce or substantially eliminate net rotational forces imposed on a rail or other structure as flexures are loaded and unloaded during use.

FIG. 6 shows a device for controlled friction. The device 600 may be similar to any of the other devices and assemblies described herein, and may include one or more of the features described herein. In this device 600 a collection of opposingly oriented flexural elements allows net torque equalization. In this arrangement, a first set of flexural elements 602 may tend to impose rotational forces in one direction (e.g., clockwise) as the flexural elements 602 are loaded and unloaded, while a second set of flexural elements 604 tend to impose rotational forces in a second, opposing direction (e.g., counterclockwise) as the flexural elements 604 are loaded and unleaded. This configuration may allow for the net torque due to equalize in order to reduce or substantially eliminate net rotational forces imposed on a rail or other structure as flexures are loaded and unloaded during use.

In one aspect, the device 600 may include a substantially symmetrical shape about an axis 601. In this substantially left-right symmetrical variation, self-centering may still occur but there may be a different force profile when loaded from the side, as opposed to the force profile when loaded from the top. This may be advantageous in load bearing when the load is mostly expected to come from a particular direction (in this case the top).

Extending this variation further, it can be seen that such symmetry need not exist about any particular plane, and in fact may not exist at all. The flexural elements may be differentially arranged around the rail (or other structural member relative to which the device 600 is configured to move) to produce different loading from a variety of directions, with or without symmetrical radial or rotational force cancellation. As such, the device 600 can be engineered with different numbers of flexural elements per radial sector, and/or with different thicknesses and profiles for the flexural elements, which may be structurally configured to yield a specific flexural response when a load comes from various radial directions.

It will similarly be understood that the rail geometry may also vary. For example, the rail or other structural member relative to which the device 600 is configured to move, may have any desired cross-sectional profile, such as a square, a diamond, a triangle, and so forth. In any geometric configuration, the flexural elements may be arranged to contact any flat planar surfaces, curved surfaces, or the like, in such a way to produce centering spring forces as contemplated herein, including any desired accommodation for dimensional tolerances of the rail. More generally, such geometric variations are not limited to square or other polygonal regular shapes with symmetry. For example, the rail may be of any arbitrary prism profile, which may include convex and concave portions, planar and non-planar portions, and so forth.

In addition to the radial axes, the rail (or other structural member relative to which the device 600 is configured to move) may vary along its axial dimension. That is, the rail may become wider or narrower intentionally to increase or decrease friction and change the sliding performance at desired positions along the rail.

Another variation may take advantage of the compliance of the flexural elements, allowing the rail (or other structural member relative to which the device 600 is configured to move) to curve along some or all of its length. While the overall friction may be greater than with a straight rail of equal cross-sectional dimensions, the rail curve radius can be gentle to allow sliding, and/or the flexural elements may be arranged to accommodate such curvature without imposing substantial friction against linear motion. As a significant advantage, this permits low-friction engagement with curved and/or changing rail paths, which is typically difficult or impossible with precision linear rail hardware due to very small bearing clearances.

More generally, the devices described herein may be advantageously applied over a wide range of morphological variations, all of which may benefit from distributed forces and points of contact achieved by the flexural elements described herein.

In another aspect, the flexural elements may be directed radially outward. Such an inverted carrier, instead of riding on a rail or the like, may instead ride inside a tube or the like. If such a tube is round, the same self-centering as described herein may be provided, as well as point-defect-tolerant behavior. Moreover, such a variation may provide dimensional diameter variation tolerance for the tube or the like. The flexural elements may be symmetrically or spirally arranged within such a tube, and a carrier for the flexural elements may in general have an arbitrary length and an arbitrary number of contact points from the flexural elements. The flexural elements may be equidistant and morphologically equivalent, or they may be differentially arranged to provide different loading or tolerance in different directions as described herein. Further, the tube (or the like) need not be straight, but may have an arc accommodated by the flexural elements. Additionally, the tube (or the like) may not have a round profile, but may instead be square (or another polygonal shape) or have other internal features that can be accommodated by a discontinuous internal device.

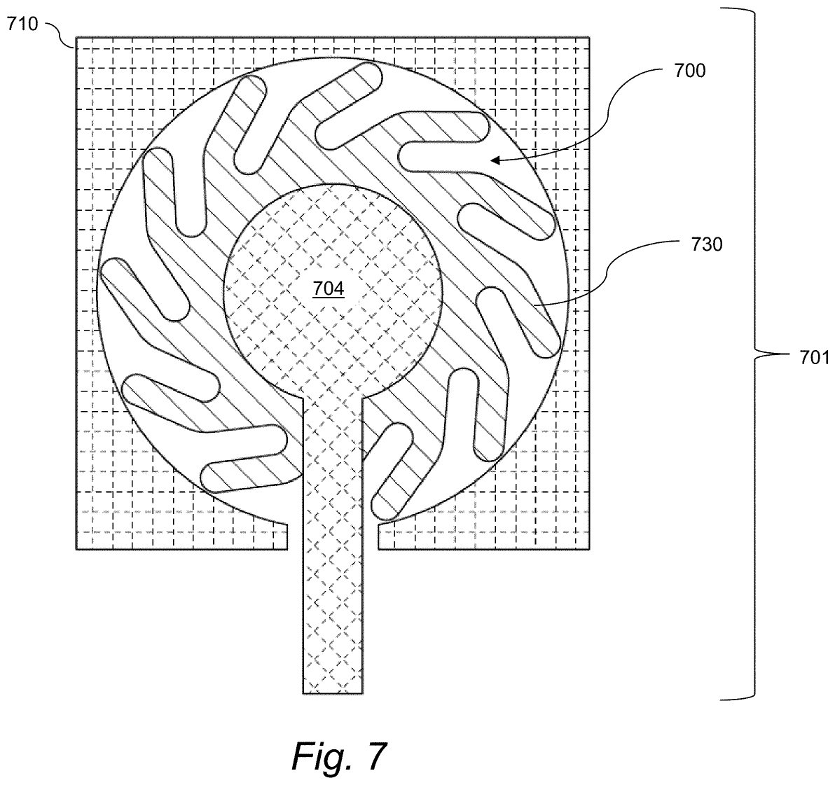

FIG. 7 shows a system for controlled friction. The system 701 may include a device 700 for low-friction sliding engagement of a block 710 to a rail 704, where the block 710 and/or rail 704 may be any as described herein. The block 710 shown in this figure may represent am element that moves (e.g., slides) relative to one or both of the device 700 and the rail 704. Thus, the block 710 may be a sliding element that is made out of internally polished metal or another smooth rigid material.

In an aspect, the device 700 may be coupled to the rail 704 such that the block 710 moves relative to both the device 700 and the rail 704. For example, the device 700 may be permanently affixed to the rail 704, the device 700 may be a part of or an extension of the rail 704 itself, and/or the device 700 may be coupled to the rail 704 in a manner that resist axial movement. In this manner, the rail 704 may provide a rigid substrate with flexural elements 730 extending therefrom, the rail 704 and the flexural elements 730 cooperatively configured to support the block 710 in a low-friction, sliding engagement. Although illustrated as separate components, the rail 704 and the device 700 may be combined into a monolithic unit.

The arrangement shown in the system 701 may allow for the device 700 to provide friction and self-centering as the block 710 moves along its axial path. Friction may be controlled by the flexural elements 730, and restoring forces may be directionally varied as described herein. In one aspect, the flexural elements 730 may be agitated (e.g., via ultrasonic vibration) to reduce the frictional engagement with the block 710, either continuously, or at desired intervals to intermittently control friction.

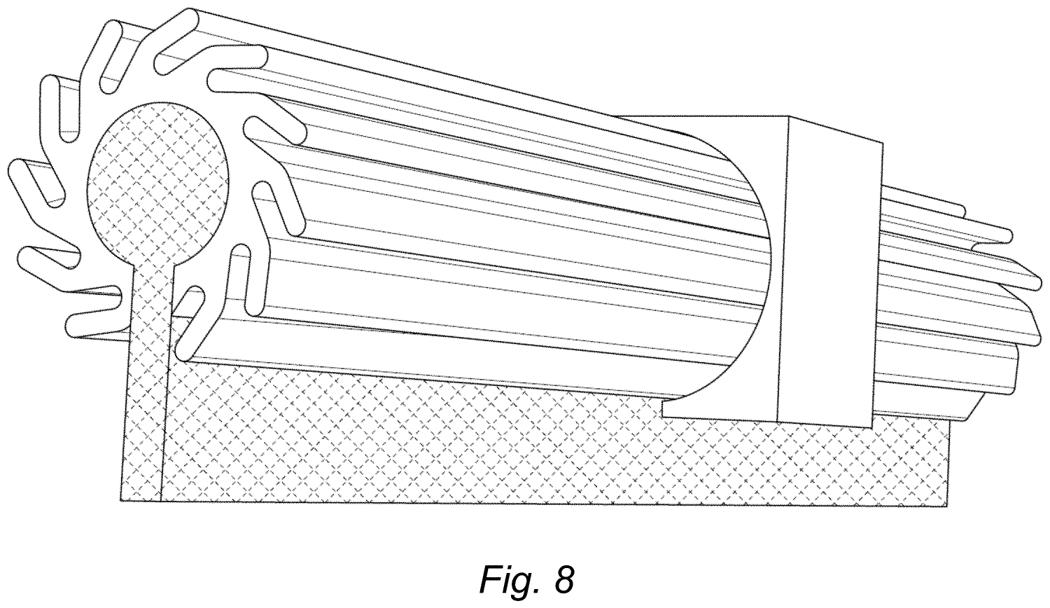

FIG. 8 shows a system for controlled friction. In particular, FIG. 8 shows a three-dimensional view of the system of FIG. 7.

In another aspect, a stationary rail and/or a sliding block may include a coaxial or parallel-axial combination of any of the configurations described herein.

For example, two coaxial rails may be coupled to an integral block with two openings and two sets of flexural elements. As another example, a coaxial rail in the center of a tube may accommodate a slider that has both inward flexural elements interfacing with the rail, and outward flexural elements interfacing with the inner surface of the tube. This may be easily visualized as concentric circular features, but there is no requirement that the rail be round or concentric with a tube, which likewise need not be round. Either or both the tube and the rail may be varied in profile or curvature to effect various frictional and loading differences.

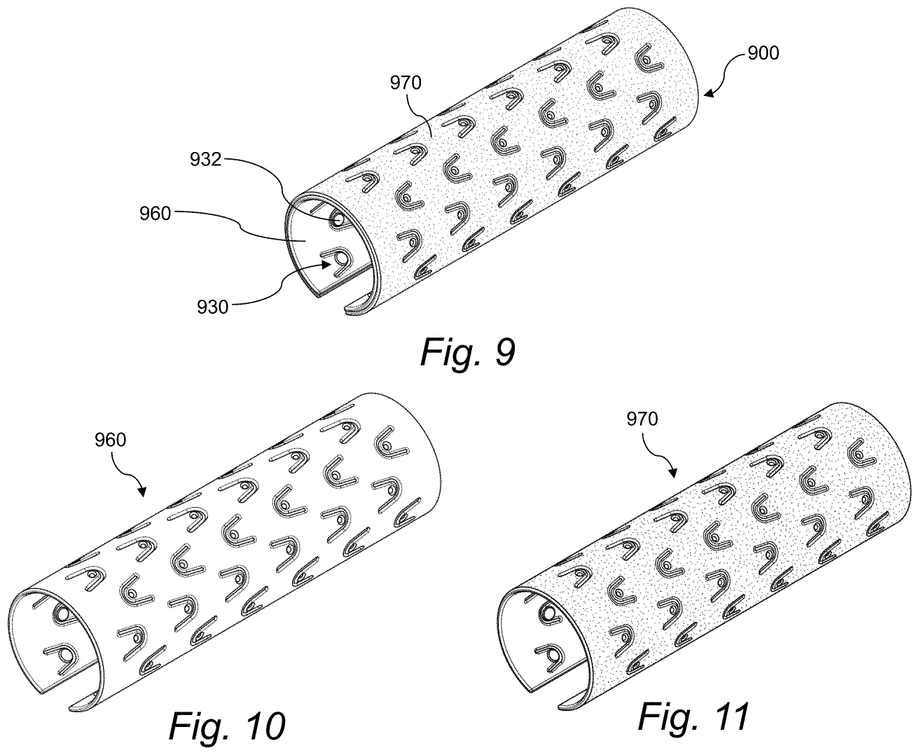

FIG. 9 shows an assembly for controlled friction. Similar to other embodiments, the assembly 900 may include a plurality of flexural element 930. In this embodiment, the assembly 900 may include one or more sleeves—e.g., a first sleeve 960 (e.g., an inner sleeve as shown in the figure) and a second sleeve 970 (e.g., an outer sleeve enveloping the inner sleeve as shown in the figure). In an aspect, the second sleeve 970 includes a material that is more rigid than the material of the first sleeve 960, while the first sleeve 960 includes a low-friction material for forming a low-friction interface with a rail or the like. Thus, in an aspect, the second sleeve 970 may stabilize, support, and/or bias the first sleeve 960, while the first sleeve 960 facilitates sliding. More generally, this configuration permits independent design and engineering of frictional properties at the interface with a rail on one hand (e.g., through a selection of materials for the first sleeve 960), and spring properties of the flexural elements that provides centering forces about the rail on the other hand (e.g., through a selection of materials for the second sleeve 970). This decoupling of two functional properties advantageously facilitates the use of a significantly wider range of materials and designs according to cost and other design specifications.

For example, in one aspect, the second sleeve 970, the exterior sleeve that does not directly contact a rail, may be engineered to control spring forces of the assembly 900 by providing support for flexural elements in the first sleeve 960. At the same time, the first sleeve 960, the interior sleeve that is in direct contact with the rail, may be engineered to control the contact shape with which surfaces of the assembly 900 contact the rail. The contact surfaces of the first sleeve 960 may also include any number of functional surfaces or surface treatments. For example, the contact surfaces of the first sleeve may include a low-friction coating, a wear-resistant coating, and electrically conductive coating (e.g., for grounding or carrying electrical data/control signals, etc.). In one aspect, the contact surfaces of the first sleeve 960 may incorporate a material such as polyoxymethylene, which has high abrasion resistance and a very low coefficient of friction with many surfaces, or a self-lubricating material with a solid lubricant phase such as graphite or polytetrafluoroethylene that transfers to working surfaces during use and wear.

The plurality of flexural element 930 may each provide an axially projected contact area 932 extending toward another member upon which the assembly 900 is configured to slide (or otherwise move) such as a rail. The axially projected contact area 932 of each of the flexural elements 930 may vary according to a contact force with the rail (or the like). And each flexural element 930 may have a spring profile that varies radially according to the contact force with the rail while resisting axial deflection, based on the aggregated elastic properties of the first sleeve 960 and the second sleeve 970 at each location. Further, the plurality of flexural elements 930 may be arranged about an axis to provide complementary radial forces on the rail or other structure to which its engaged.

In one aspect, the flexural elements 930 in the assembly 900 may include cutouts or the like from the sleeve that form cantilevered regions with extending arms that are aligned, e.g., along a longitudinal axis of the sleeves. On a surface facing the rail (or other structure), the cantilevered portion may include a projection such as a hemisphere or other shape that forms the axially projected contact area 932 for engaging the rail.

FIG. 10 shows a device for controlled friction. Specifically, this figure shows an example of the first sleeve 960 of FIG. 9, which forms the inner layer of the assembly 900 coming in contact with a rail or the like.

FIG. 11 shows a device for controlled friction. Specifically, this figure shows an example of the second sleeve 970 of FIG. 9, which forms the exterior layer of the assembly 900, providing structure reinforcement and helping to control the spring constant of the flexural elements 930 in the first sleeve 960.

In one aspect, the flexural elements described herein may include an axially projected contact area that extends radially toward a rail or the like. The axially projected contact area of the flexural elements may have specific engagement surfaces and/or surface features to control frictional engagement with the rail. Some examples of these engagement surfaces are described below.

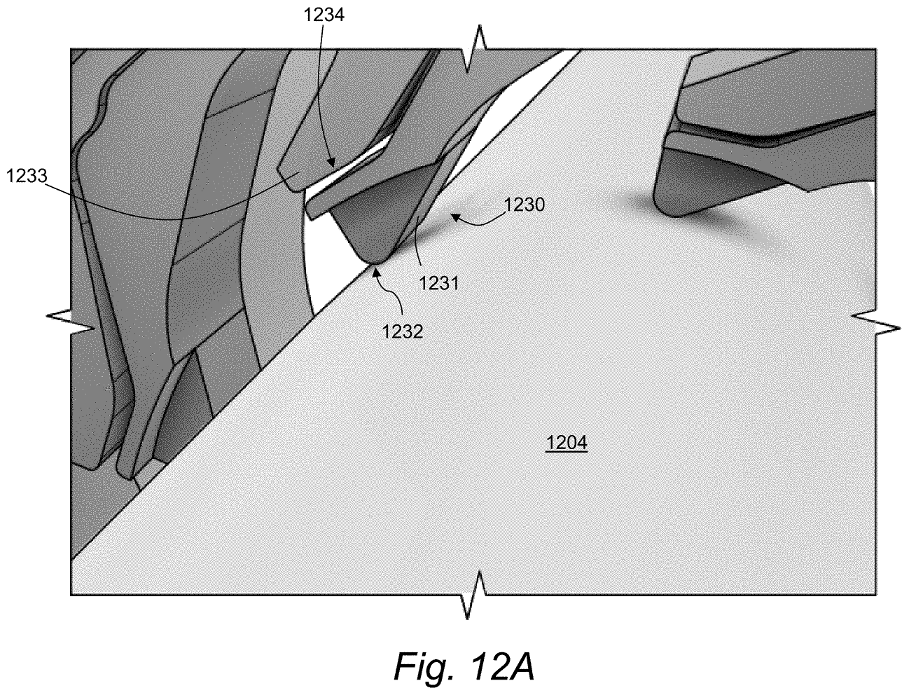

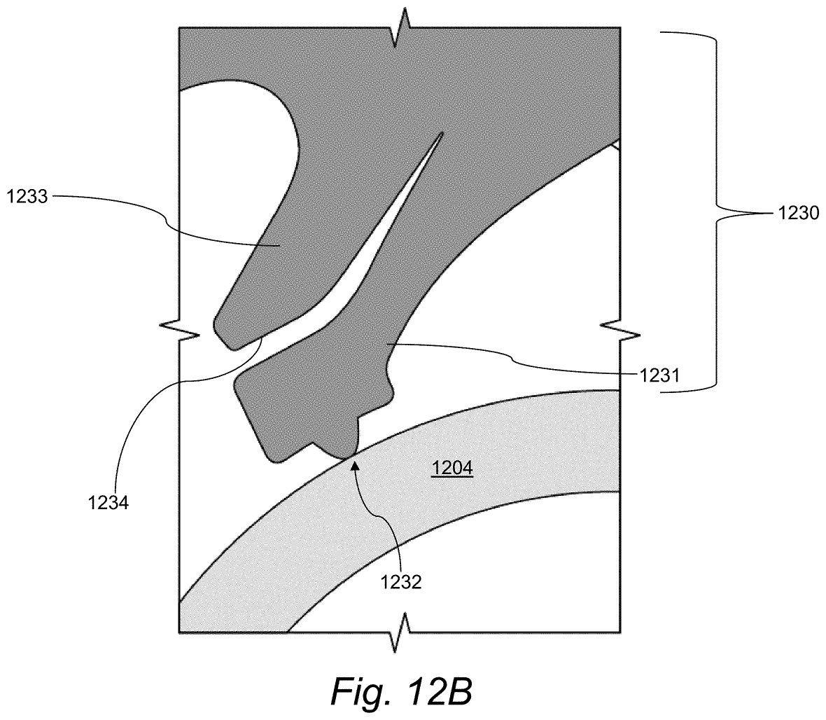

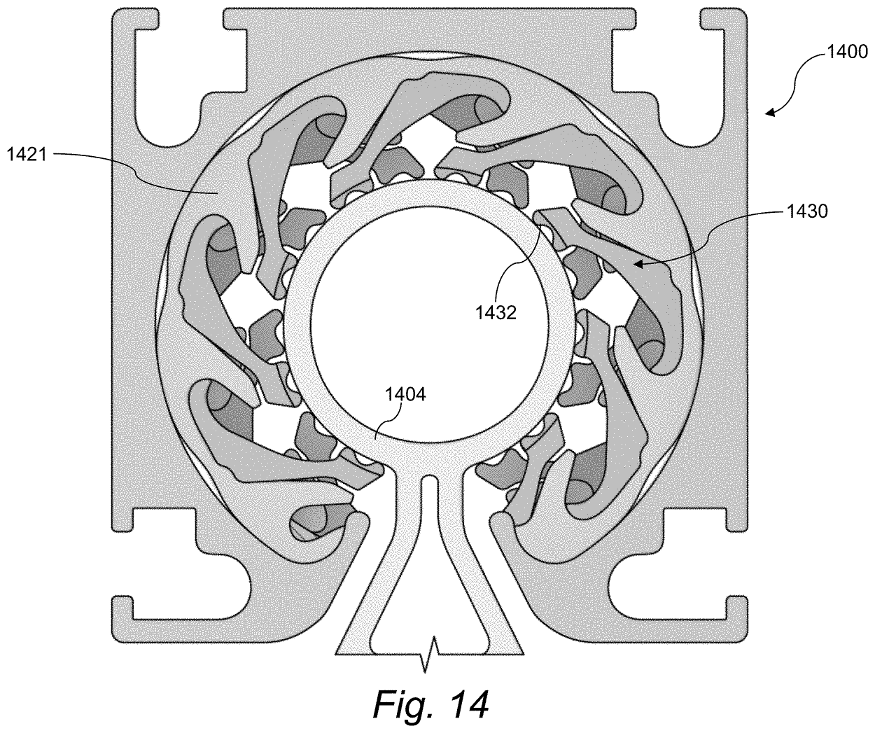

FIGS. 12A and 12B show engagement of a flexural element with a rail. In one aspect, a flexural element 1230 may include a first arm 1231 with an engagement surface 1232 and a second arm 1233 with a support surface 1234. In general, the support surface 1234 of the second arm 1233 may enforce a force profile and/or spring profile for the flexural element 1230 by providing increased resistance to deflection when a first arm 1231 deflects under a load into contact with the support surface 1234 of the second arm 1233, at which point further deflection requires increased force to displace both the first arm 1231 and the second arm 1233. It will be understood that the first arm 1231 and the second arm 1233 of the flexural element 1230 may be connected as shown by way of example in FIG. 12B. Also or instead, the first arm 1231 and the second arm 1233 may be projected from separate substrates that can collectively form a flexural element 1230, where an example of this configuration is shown in FIG. 14.

Turning back to FIGS. 12A and 12B, an aspect of a flexural element 1230 may include an engagement surface 1232 formed on a portion thereof (i.e., the axially projected contact area of the flexural element 1230) that has a substantially convex shape with an apex directed toward a rail 1204 or other contact surface. Thus, in some aspects, the engagement surface 1232 of the flexural element 1230 may essentially be shaped as a small cylinder, where the rounded exterior surface of the cylinder frictionally engages with the rail 1204. When the rail 1204 is also a cylinder or the like (or otherwise has a convex rounded surface), contact between the engagement surface 1232 of the flexural element 1230 and the rail 1204 can be represented as two cylinders engaging one another. While this may provide preferred frictional engagement for controlling friction between these elements when there is line contact, this configuration can be relatively sensitive to surface variations on one or more of the opposing surfaces, especially when undergoing relative motion. This configuration can thus be inherently unstable, where increasing pressure can decrease stability. In order to address this potential instability, each flexural element may incorporate a compound engagement surface that provides multiple contact surfaces.

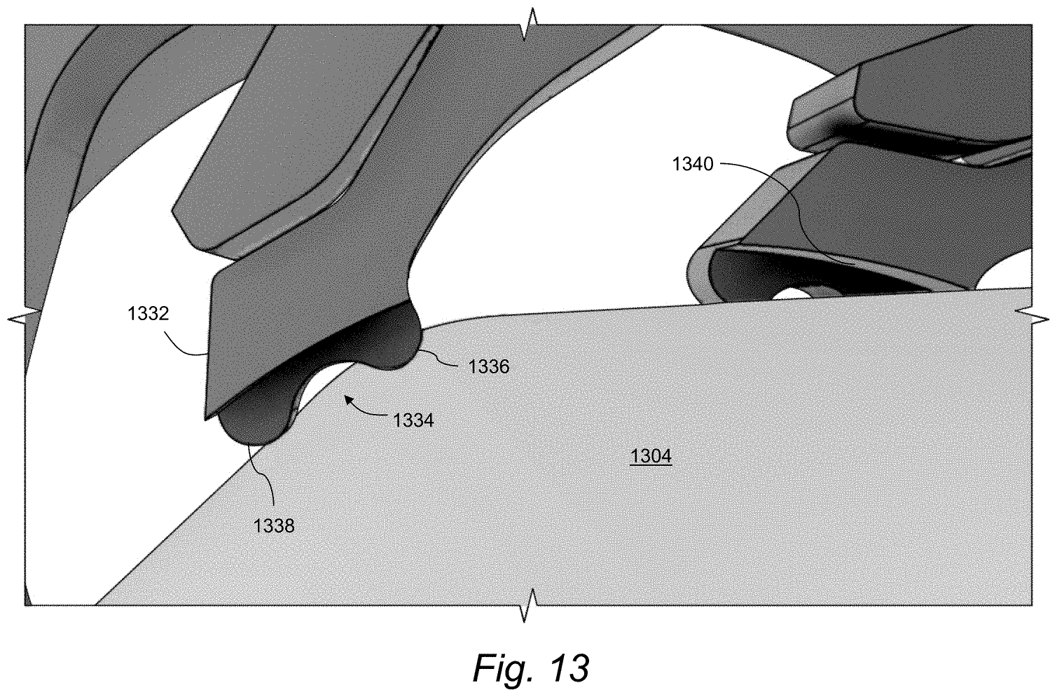

FIG. 13 shows a flexural element with a compound engagement surface. The flexural element 1332 may generally include a compound engagement surface 1334 with a plurality of contact points or contact surfaces for frictional engagement with a rail 1304. This may, for example, include a first contact surface 1336 and a second contact surface 1338 of the compound engagement surface 1334. However, it will be understood that other configurations and/or numbers of contact surfaces are also or instead possible. For example, a compound engagement surface 1334 may have three or more contact surfaces, four or more contact surfaces, and so forth. Furthermore, these contact surfaces 1334 may usefully incorporate prismatic projections (e.g., as illustrated in FIG. 13), hemispheric sections, pyramids or other substantially point contact surfaces, truncated pyramids, spherical surfaces, spheroidal surfaces, or other convex, curved surfaces, or the like, as well as combinations of these.

More generally, each compound engagement surface 1334 may provide a stability-enhancing contact surface for a flexural element, and/or promote multi-point or multi-surface contact that distributes engagement force to stabilize contact between the flexural element 1332 and a rail or other contact surface. In one aspect, the compound engagement surface 1334 may form a complex radial contact surface, e.g., that contacts a rail or the like along multiple physically separated regions about the radius of the rail. In another aspect, the compound engagement surface 1334 may form a complex axial contact surface, e.g., that contacts a rail along multiple physically separated regions along the axis of the rail, or, as illustrated in FIG. 13, that extends only partially along an axial extent of the flexural element 1332, leaving an overhang 1340 where the flexural element 1332 does not contact the rail 1304. This advantageously permits control of a spring profile for the flexural element 1332 (e.g., by controlling axial depth) independently from the shape and size of contact surfaces formed between the compound engagement surface 1334 and the rail 1304.

FIG. 14 shows a multi-part device for coupling a block to a rail. The device 1400 may include flexural elements 1430 with a compound engagement surface 1432. As shown in this figure, the inclusion of flexural elements 1430 with compound engagement surfaces 1432 as pictured (i.e., with two contact surfaces thereon) may double the number of contact points between the device 1400 and the rail 1404 while creating a more mechanically stable engagement with the corresponding contact surfaces. For example, it has been observed that flexural elements with single contact points or contact surfaces such as simple fins or the like are prone to unstable engagement with a rail during sliding motion, and may oscillate or move erratically when loaded and sliding. The use of compound engagement surfaces 1432 that provide contact at multiple, physically separated regions can advantageously support more stable engagement with a rail or other surface under dynamic conditions, e.g., when loaded and sliding. The compound engagement surfaces 1432 may also or instead increase the circumferential coverage about the rail 1404, lower contact point pressures, lead to less wear over time, and so on.

In one aspect, the device 1400 may be formed from multiple inserts, each fabricated from a different material (or combination of materials). For example, the flexural elements 1430 may be formed of a first material selected for frictional properties (and/or a first elasticity/stiffness), and may arranged as a single piece including all of the flexural elements 1430 about the circumference of the device, or multiple independent pieces that are individually fitted into or retained by a separate portions of a retaining structure. An insert 1421 may be shaped to retain the flexural elements 1430 in desired positions and orientations relative to a rail or other sliding surface. The insert 1421 may also or instead provide a relatively rigid backstop to constrain or increase resistance to deflection of the flexural elements 1430 beyond some predetermined deflection point, or more generally, may be formed of a material selected to cooperate with the flexural elements 1430 to provide a desired spring profile to the device 1400 as it responds to radial loads when engaging a rail 1404. As described herein, this may advantageously permit decoupling, in terms of design and material selections, of the frictional properties of the flexural elements 1430 and the spring forces provided by the insert 1421.

According to the foregoing, the controlled-friction devices described herein provide low-cost alternatives for low-friction sliding assemblies, and facilitate active control of sliding behavior in a manner not possible with current high-precision bearing assemblies. Also according to the foregoing, there are described herein methods for controlling frictional engagement with linear rails (or curvilinear rails) and the like by fabricating interface components with flexural elements and deploying the interface components to couple moving components to the linear rails. This may include active control, e.g., using actuators to control the amount of frictional engagement and other characteristics of the coupling between the interface component(s) and a rail or the like.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A system for coupling a block to a rail having an axis:
a substrate shaped along the axis to frictionally engage the block; and
a plurality of flexural elements, each providing an axially projected contact area extending toward the rail that varies according to a contact force with the rail and each having a spring profile that varies radially according to the contact force with the rail while resisting axial deflection, wherein the plurality of flexural elements are arranged about the axis to provide complementary radial forces on the rail.

2. The system of claim 1, wherein one or more of the plurality of flexural elements include cantilevered arms extending at an angle to a direct radial path to the axis of the rail.

3. The system of claim 1, wherein at least one of the flexural elements includes a low-friction material on at least a portion of the axially projected contact area that contacts the rail when placed for use on the rail.

4. The system of claim 1, wherein at least one of the flexural elements is supported by a rigid backstop positioned to increase resistance of the one of the flexural elements beyond a predetermined threshold.

5. The system of claim 1, wherein at least one of the flexural elements includes a compound engagement surface shaped to contact the rail along two or more different surfaces.

6. The system of claim 1, wherein the plurality of flexural elements are directed radially outward to engage one or more interior cross-sectional surfaces of the rail.

7. The system of claim 1, wherein the plurality of flexural elements are directed radially inward to engage one or more exterior cross-sectional surfaces of the rail.

8. The system of claim 1, wherein the plurality of flexural elements include a first set of flexural elements imposing rotational forces in a first direction when loaded and unloaded, and a second set of flexural elements imposing rotational forces in a second direction opposing the first direction when loaded and unloaded.

9. The system of claim 1, further comprising the block and the rail.

10. The system of claim 9, wherein the rail is a linear rail.

11. The system of claim 9, wherein the rail is a curvilinear rail.

12. The system of claim 9, further comprising a plurality of devices, each including a substrate shaped to engage the block and a plurality of flexural elements, the plurality of devices positioned along the block to engage the rail at different linear locations.

13. The system of claim 1, wherein the substrate and the flexural elements are formed of different materials.

14. The system of claim 13, wherein the flexural elements are formed in a first cylindrical element nested within a second cylindrical element containing the substrate.

15. The system of claim 14, wherein the flexural elements have a sliding friction controlled by one or more materials of the first cylindrical element.

16. The system of claim 14, wherein a spring behavior of the flexural elements is controlled at least in part by a material of the second cylindrical element.

17. The system of claim 13, further comprising a functional coating on one or more of the flexural elements.

18. The system of claim 13, wherein the flexural elements are formed of a material selected for elasticity and spring force of the flexural elements against the rail.

19. The system of claim 1, wherein at least one of the plurality of flexural elements includes a compound engagement surface for contacting the rail.

20. The system of claim 1, wherein one or more of the plurality of flexural elements provides a non-linear spring force with a spring constant that increases with increasing radial force.
